(19) United States
(12) Patent Application Publication
(10) Pub. No.: US 2009/0321317 A1
(43) Pub. Date: Dec. 31, 2009

(54) METHOD AND DEVICE FOR PROCESSING PLASTIC-CONTAINING WASTE

(75) Inventors: Christian Widmer, Binningen (CH); Rudolf Hartmann, Gelterkinden (CH); Gerold Weser, Dattwil (CH)

Correspondence Address: DAVIS & BUJOLD, P.L.L.C., 112 PLEASANT STREET, CONCORD, NH, 03301, US

(73) Assignee: GRANIT SYSTEM S.A., Lausanne (CH)

(21) Appl. No.: 12/438,647

(22) PCT Filed: Aug. 23, 2007
(86) PCT No.: PCT/EP07/07419

§ 371 Date: Aug. 10, 2009

(30) Foreign Application Priority Data
Aug. 25, 2006 (DE) 10 2006 039 824.6
Sep. 29, 2006 (DE) 10 2006 046 682.9
Nov. 22, 2006 (DE) 10 2006 055 388.8
Aug. 23, 2007 (DE) 10 2007 039 887.7

(51) Int. Cl. B01J 19/00; C10G 11/00; F28D 21/00

(52) U.S. Cl. 208/113; 422/129; 422/202; 422/198

(57) ABSTRACT

The invention relates to a method and device for processing plastic-containing and organic fluids based on crude oil, cooking oil, fats or the like, wherein the substance mixture is fed into a reactor, is then melted in the melting zone of the reactor and the interfering substances are discharged from the melt. The long-chained polymers still present in the melt are cracked in a crack zone of the reactor until they assume a gaseous state. Then the gas phase is discharged from the reactor an condensed in a cooler. Impurities are then removed from the volatile liquid present after cooling and the volatile liquid is stored.

This application is a National Stage completion of PCT/EP2007/007419 filed Aug. 23, 2007, which claims priority from German patent application serial nos. 10 2006 039 824.6 filed Aug. 25, 2006; 10 2006 046 682.9 filed Sep. 29, 2006; 10 2006 055 388.8 filed Nov. 22, 2006; and 10 2007 039 887.7 filed Aug. 23, 2007.

### FIELD OF THE INVENTION

The invention concerns a process and the equipment for the preparation of waste containing plastic and organic liquids based on mineral oil, edible oil, fat and similar.

### BACKGROUND OF THE INVENTION

In view of the increasing cost of crude oil and the ever restricting obligations attached to the processing of waste material and the recycling of scrap, there is considerable interest in the processing of plastic scrap which, for example, might be separated from residual waste.

From WO 2005/071043 A1 a procedure is known whereby plastic scrap is processed into oil.

In this procedure the separated plastic scrap is hermetically sealed, compacted and delivered to a melt container. Then follows a separation into a first liquid phase, a first gas phase and residue. The liquid phase and the first gas phase are delivered to a vaporiser in which a second liquid phase and a second gas phase separation takes place. The second liquid phase is warmed further in a secondary heater. The third gas phase and the second gas phase are delivered from the vaporising container to a cracking tower in which long chain hydrocarbons are cracked. The resulting gas is then condensed into light liquid in a condenser.

This complex process with a melt container, several vaporising or secondary heating containers, a separate crack installation and a condenser calls for a considerable investment in processing equipment.

### SUMMARY OF THE INVENTION

In view of this the object of the invention is to produce a process and the equipment with which to treat waste containing plastic with minimal investment in equipment.

According to the invention the melting, vaporising, and cracking should be arranged in a single reactor in which the melting and cracking zone are split or are in two downstream switched reactors such that the equipment costs described at the beginning are significantly reduced.

The gas phase after the crack zone will for example be taken to a distillation column that would operate such that short chain polymers condense and are then returned to the reactor crack zone. After the distillation column and the associated coolers those relatively short chained gaseous hydrocarbons can be used as fuel for energy.

The process under the invention can be carried out particularly effectively if the temperatures in the melt zone are as low as possible—approximately from 250° C. to 350° C. max—and in the crack zone approximately from 420° C. up to 450° C.

Any impurities in the reactor including non-molten plastics drop into the melting zone and into the crack zone and can be removed.

These high calorie residues can be emulsified and also used as fuel for energy.

After condensing while still in light liquid any impurities can be removed during processing for example by absorption.

The reactor with the melting zone and/or the crack zone must be fitted with a device to ensure that the melt from the entering material is continuously monitored. This supply device can, for example, be a screw feeder attached to one of the zones.

According to a preferred embodiment of the invention the material mixture, which is to be processed, can be fed to the reactor in at least two symmetrical points of entry.

It is particularly advantageous that this material be compacted prior to being loaded into the reactor.

The reactor is preferably laid out as a horizontal container.

As an example a part of the liquid product after cooling and quenching can be taken as a coolant fluid through a cooler and used as a quenching fluid for cooling and condensing gases.

The heating for melting in the melting and crack zones is preferably by means of pipes within the reactor which practically form a heat exchanger. The number of pipes, or more exactly, their heating surfaces being appropriate for the heating level required.

As mentioned before a single reactor can be supplied with a melting zone and crack zone. As an alternative two reactors can be supplied switched downstream. For the heating of the suspension heating pipes are provided within the reactor. In one version of the invention the heat input and the distribution of the heat originate from the individual pipes at the front at one end of the reactor. The output distributor and the heat output are located at the opposite side of the reactor. As mentioned the pipes provide circulation with their associated distributors and coil for removing the scaling on the internal cladding of the reactor concerned.

The single reactor with melting zone and crack zone or the two-switched downstream reactors have a heat exchanger in which the suspension or molten mass is warmed.

In one preferred embodiment these heat exchangers are provided as pipe heat exchangers in which one pipe having suspension/molten mass has an inner pipe formed into a coil which runs with the suspension and considerably improves the heat transfer with the result that the heat exchanger can be made shorter than those normally available.

In another variant it is preferable if this winding or coil abuts the cladding of the inner pipe so that any residues may be removed.

Since the suspension still contains a certain amount of solid matter, the pump and supply power units are subject to abrasive wear. To minimize this wear a version can be used with an electromagnetic clutch motor such that no part of the clutch unit is in contact with the suspension.

Pump wear can be reduced when the pump is operated magnetically with the drive solenoid located outside the area of the suspension. Preferably a double action piston pump with two cylinders should be used separated from the piston and operated via the solenoid drive.

This solenoid drive can have an external magnet covering the pump cylinder that is controlled by a linear actuator so that the stroke of the piston is in line with the linear actuator.

### BRIEF DESCRIPTION OF THE DRAWINGS

FIG. 1 represents a continually operating processing plant for mixed plastics and contaminated plastic materials separated from residual waste. Also PVC, PET and rubber are separated as foreign matter. At the time the following processes are shown as ready of which however only process (to WO 2005/071043 A1) is selected for continuous operation. The two other processes are batch driven installations and can when operating at least three units be described as continuous operation. These processes are described in JP 08 034978A (Patent Abstracts), U.S. Pat. No. 4,584,421 A and CN 12 284 537 A.

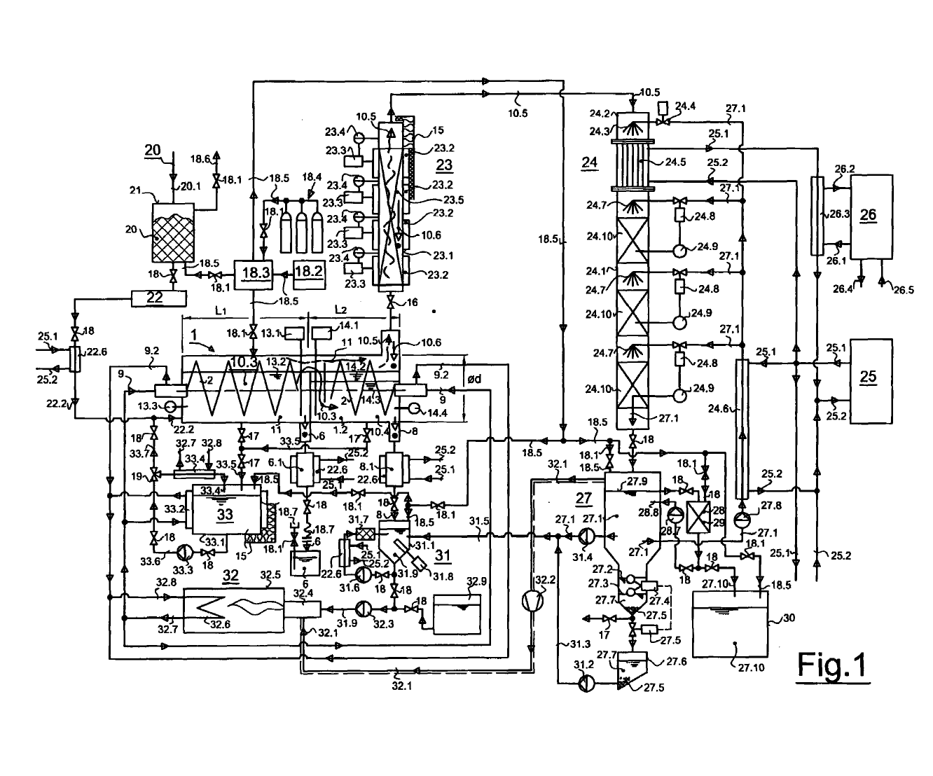

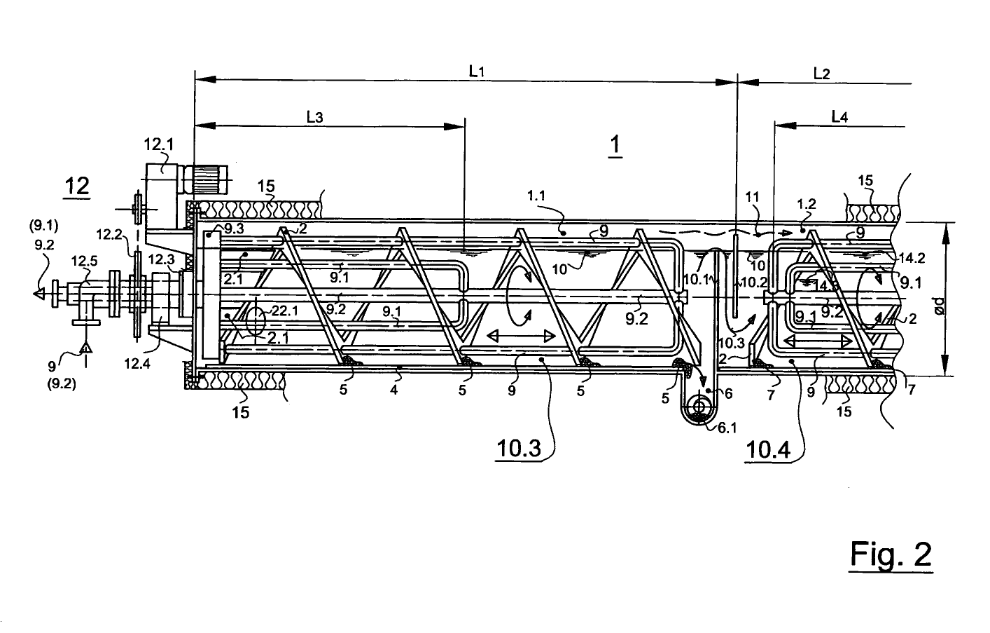

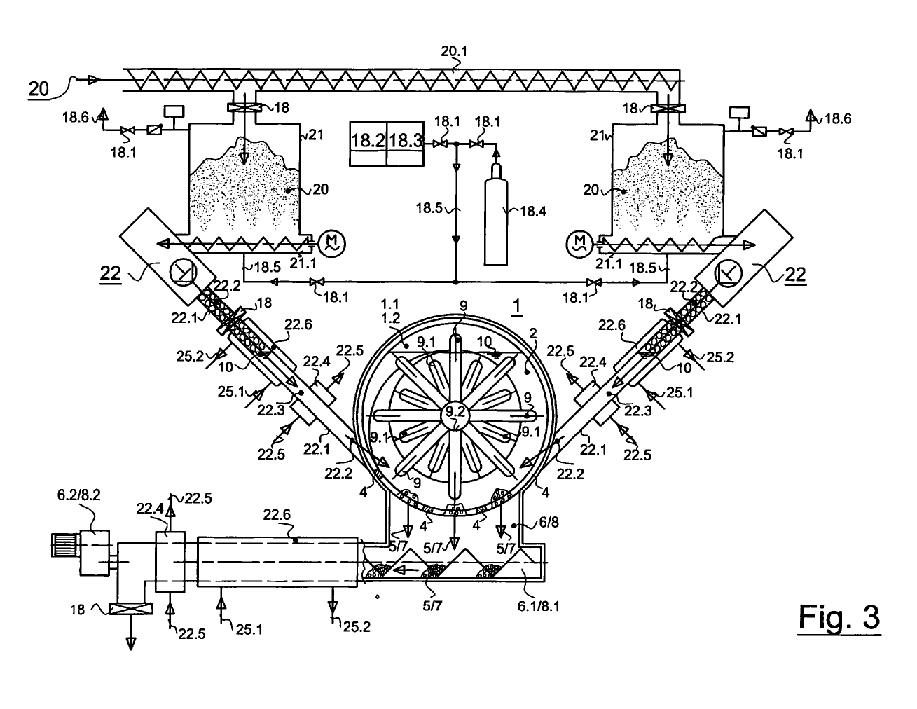

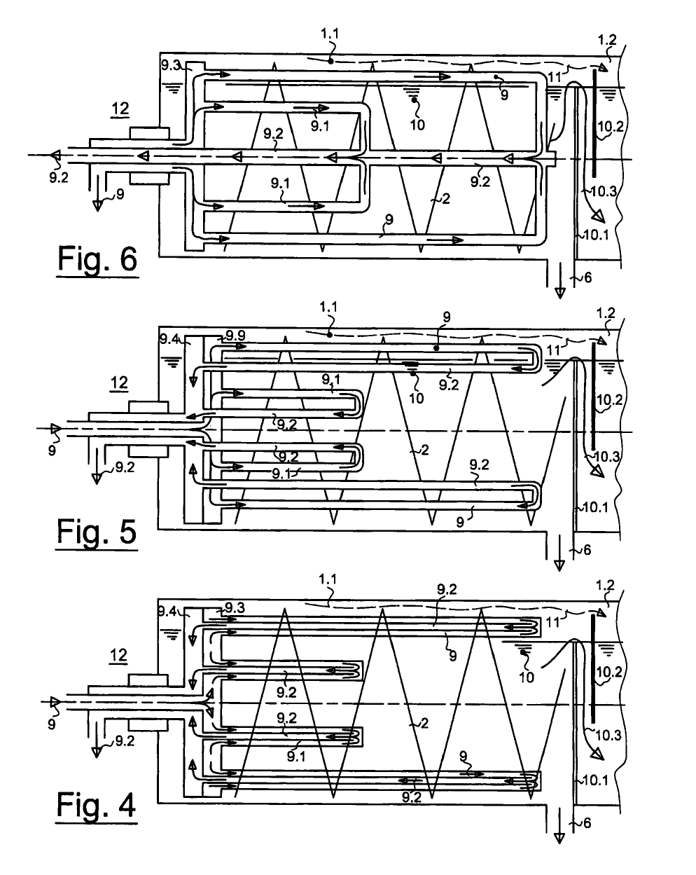

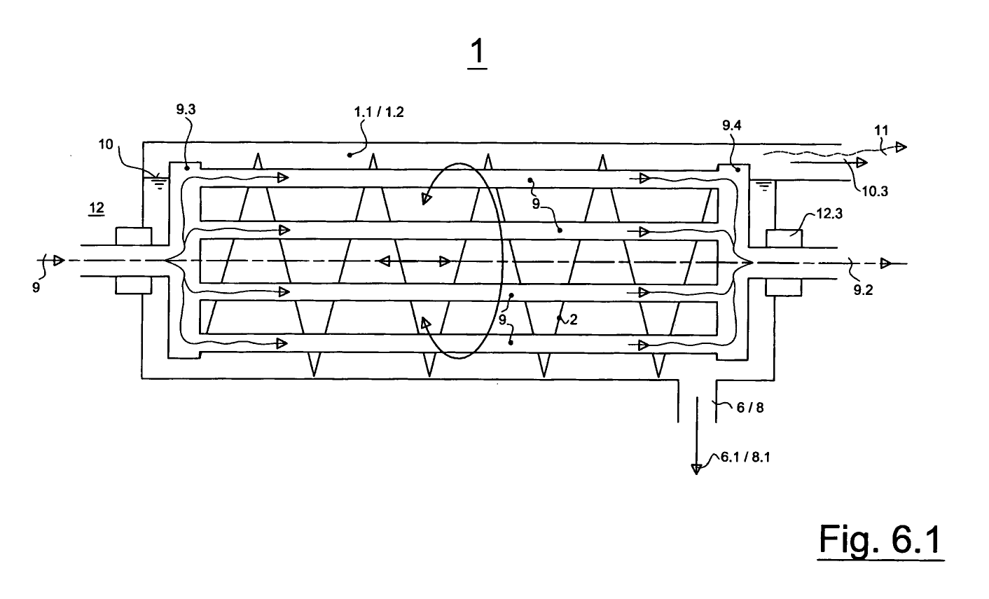

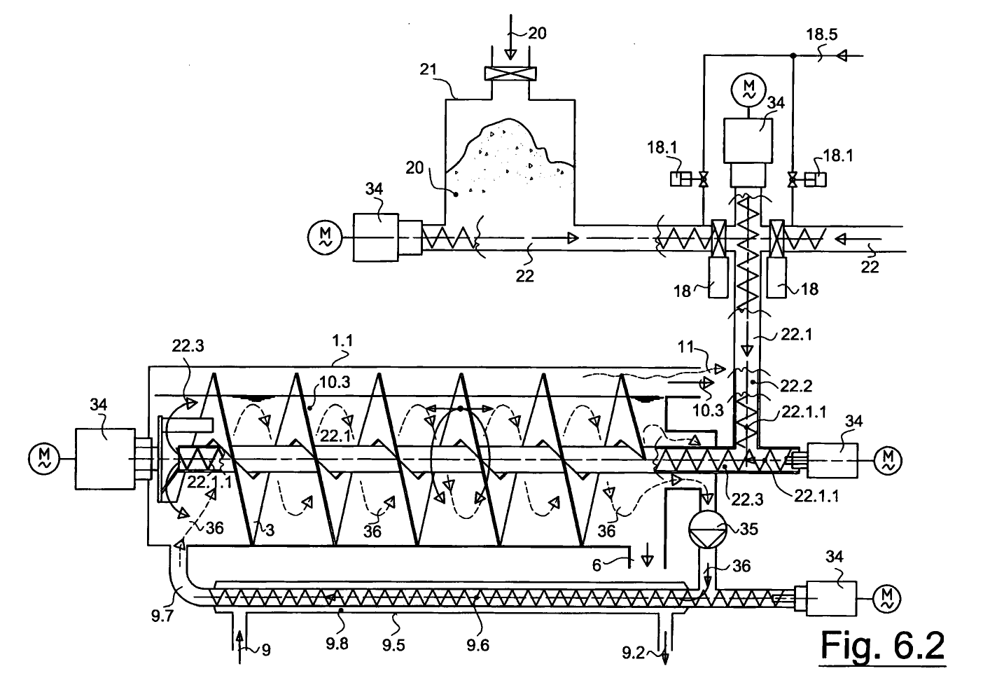

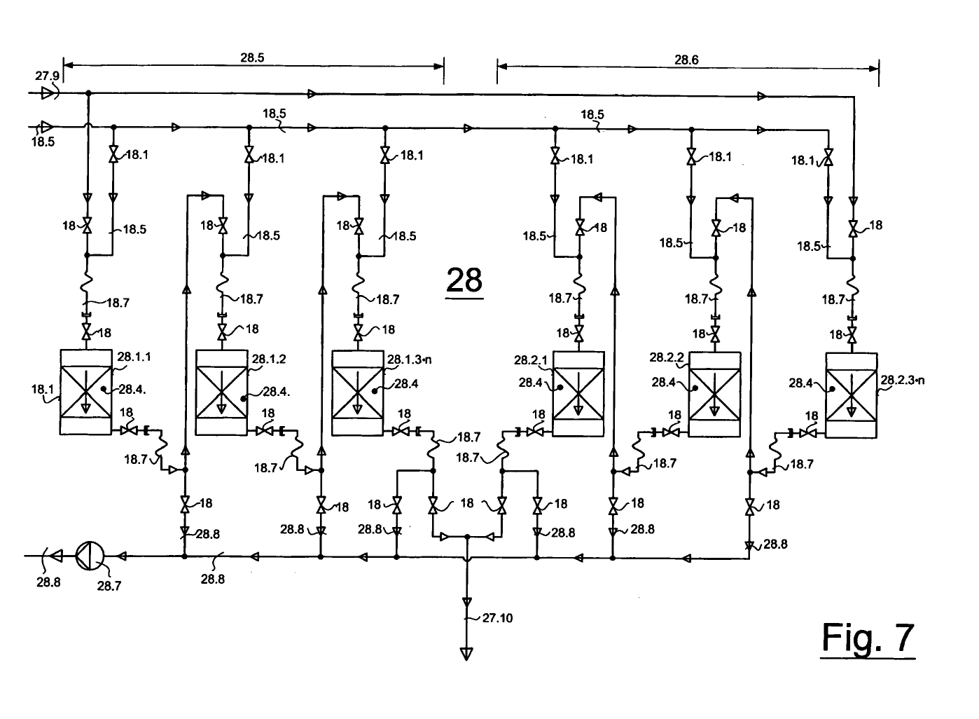

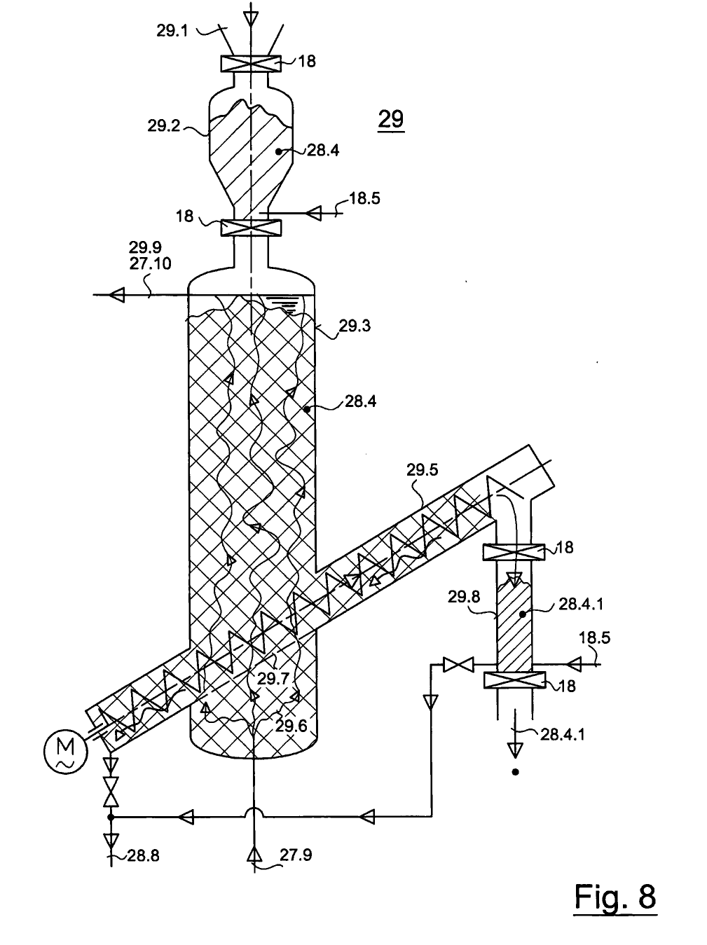

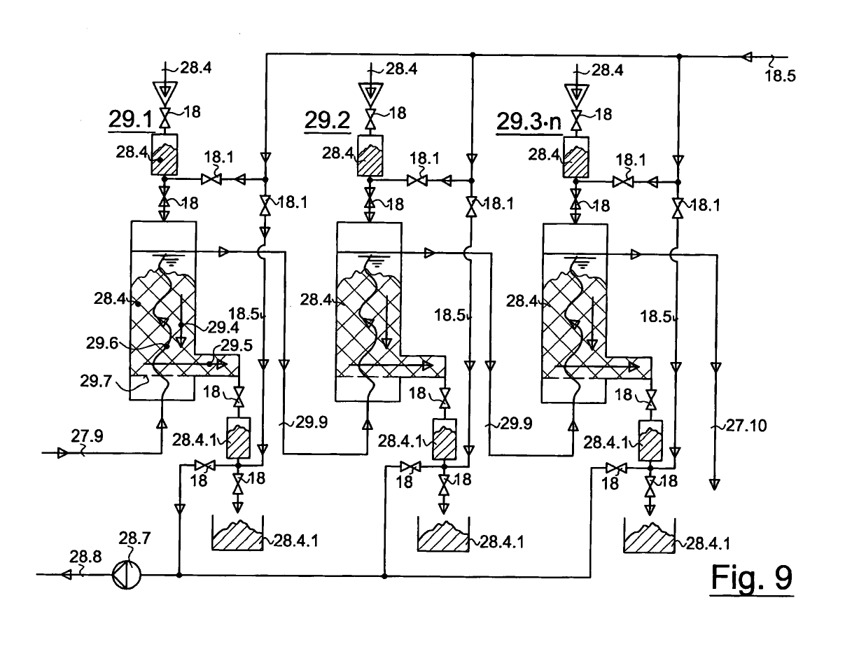

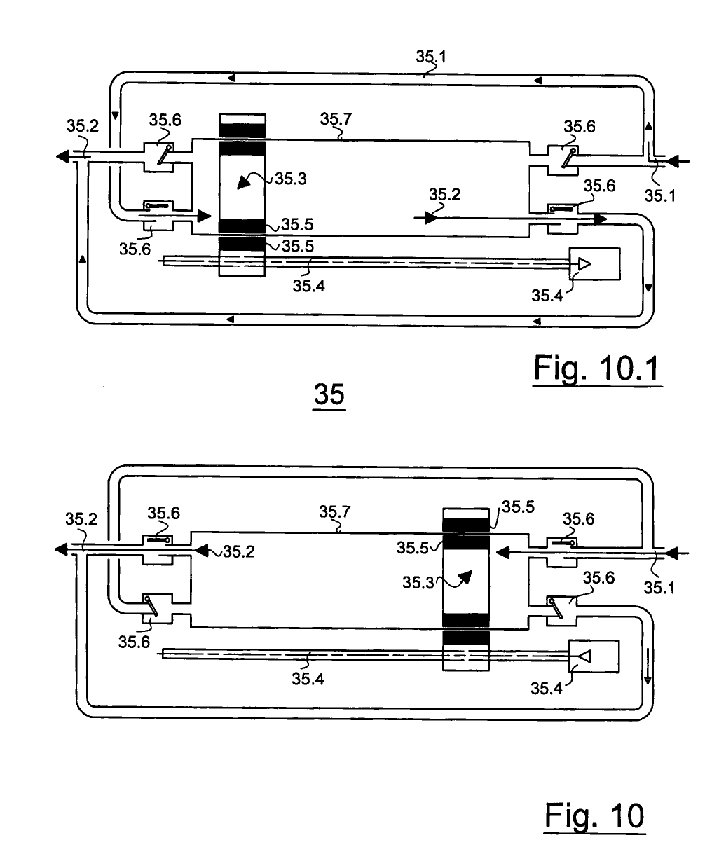

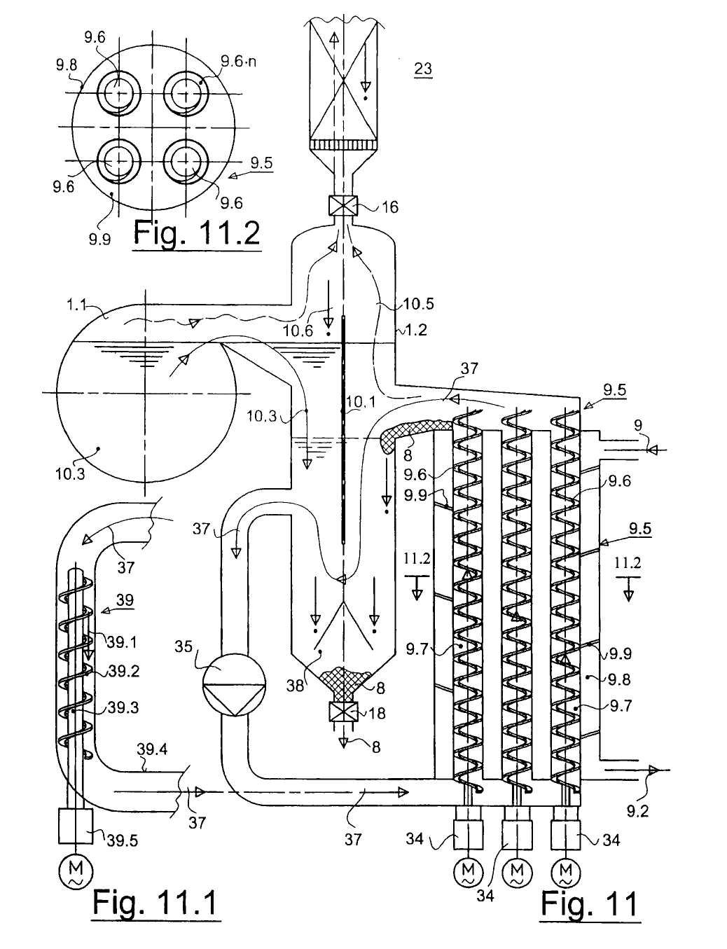

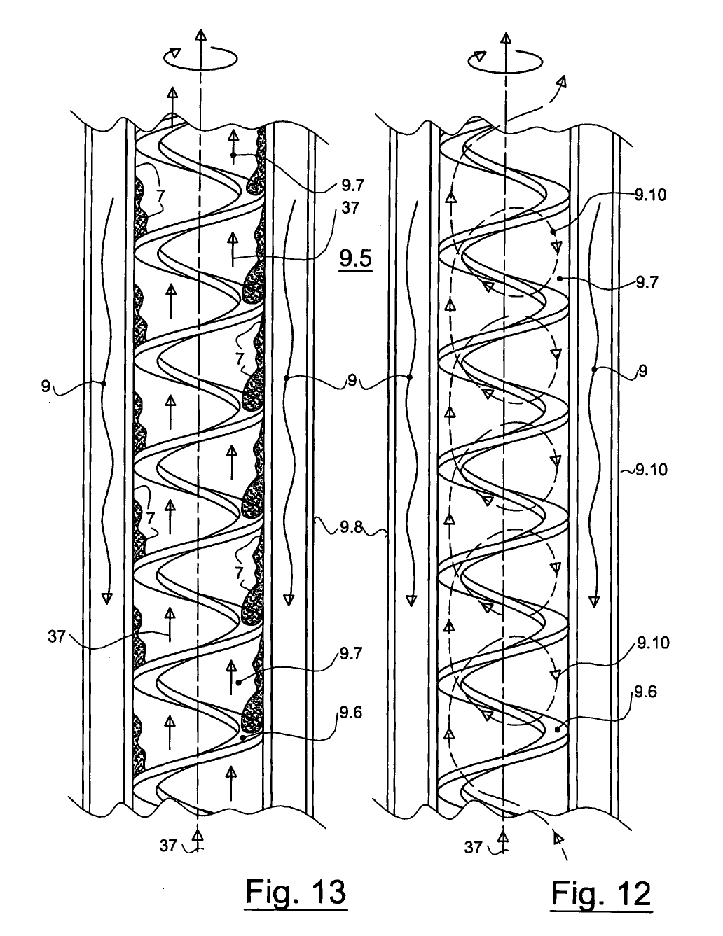

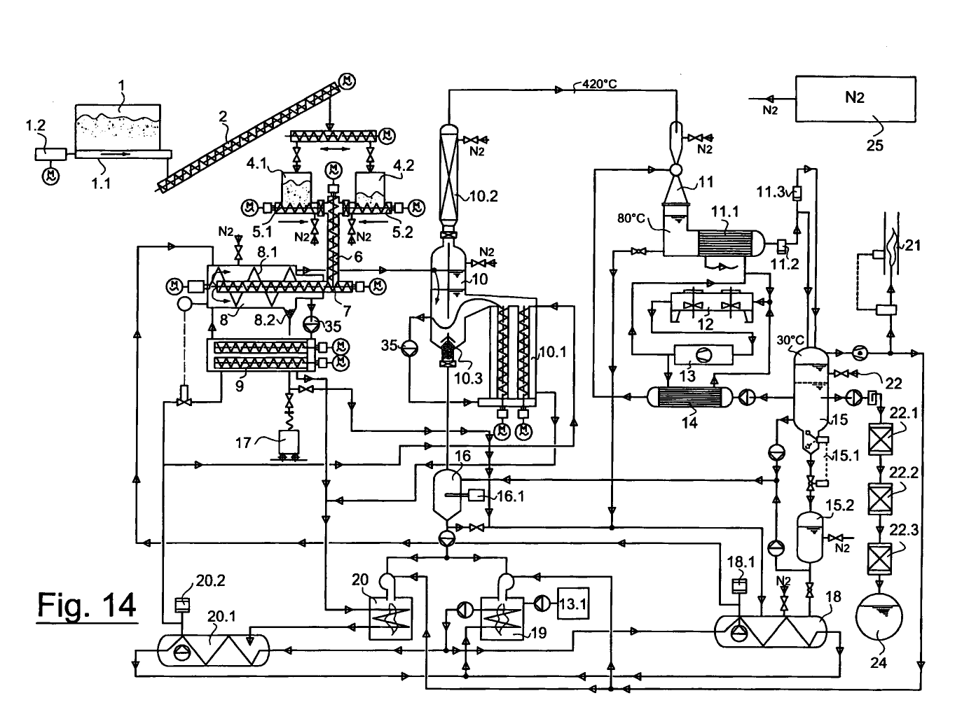

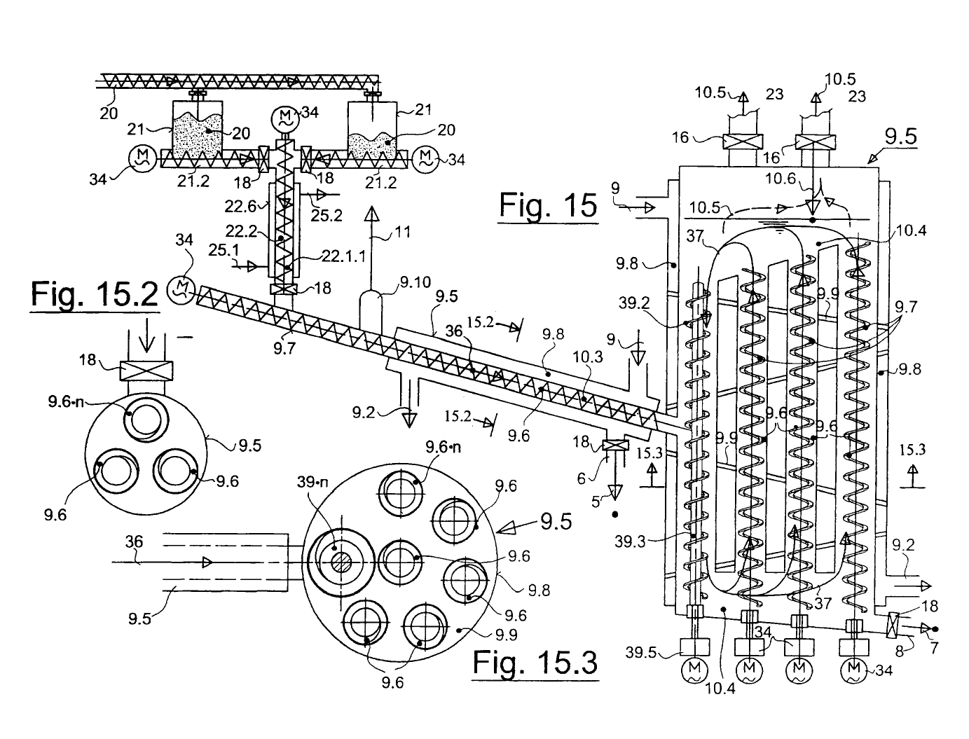

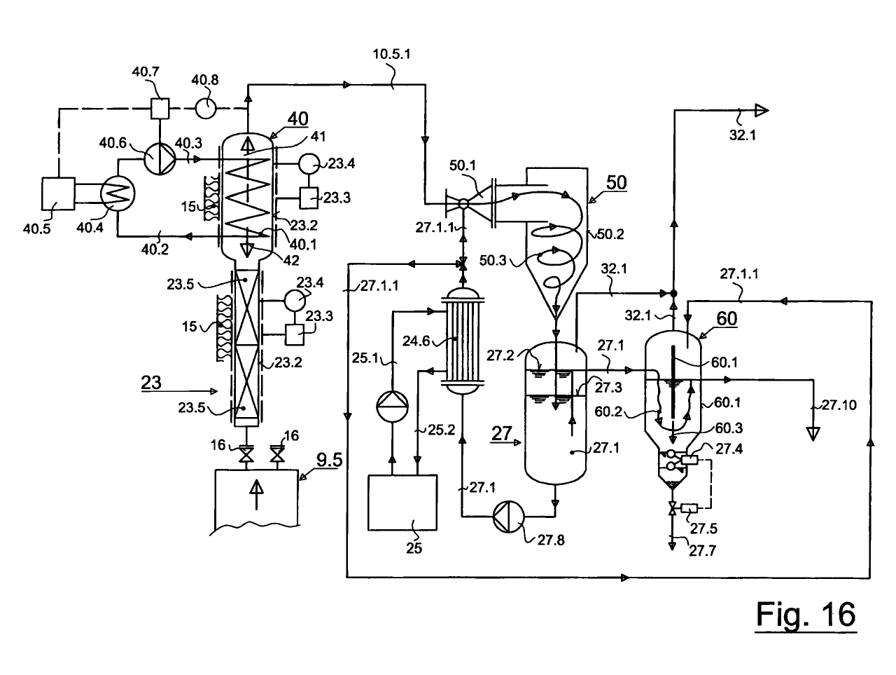

A difference between the processes mentioned and the new process as in FIG. 1 lies in the continuous feeding of at least two feed plants 20/22 in a horizontal reactor in which the following six process steps run simultaneously and use a commonly unseparated gas area.

1) Continuous feeding 20/22 of plastic materials and organic liquids based on mineral oil or edible oil and fat.

2) Melting the supplied material mixtures within the temperature range 250° C. and 350° C. to a liquid mass similar to stirred emulsion paint 10.3 in the area of the melting chamber 1.1.

3) Contaminants like sand and other non-organic substances like plastic materials that do not melt at 350° C. or non-organic paints 5 fall out and are delivered through the coil into the chute 6.1 to the special waste container that as a removable container will be disposed of in a special incinerator.

4) Via the separating wall and the skimming wall 10.1 and 10.2 the molten masses released from the foreign matter 10.3 pass into the crack zone 1.2 in which with temperatures between 420° C. and 450° C. the long chained polymers are held at temperature until they are delivered as short chain hydrocarbons to the distillation column in the form of gas 10.5 and mixed with the gases 11 from the melting stage 1.1.

5) The distillation tower 23 is in this respect so designed that long chain hydrocarbons condense as C24 and return to the crack reactor 1.2 and remain there until they are shorter than C24. The bandwidth at cracking lies between C1 and C22 with the majority between C12 and C16 (predominantly methane) up to C4 (predominantly propane) remain at the specified temperature in the distillation tower 23 in the form of gas 32.4 for salt heating.

6) Of high energy but not in the form of gas tar and bitumen type substances such as the hydrocarbon excess arising from cracking polymers sink in reactor part 1.2 and are delivered via the chute 8 and by the removal device 8.1 into a container 31.9. This residue 7 can be emulsified with the water 27.7 from the product and water separation container and with the product similar to heating oil 27.1 in tank 31.9 by means of ultra sound 31.8 and disposed of as fuel for the salt heating in the multi-fuel stove 32.4 as high calorie liquid fuel 31.9 or optionally used in a liquid fuel stove.

Since substrates similar to heating oils condensed contaminants, sulphur traces, particularly sulphuric acids, halogen acids e.g. hydrochloric acids (HC2) and possibly disturbing organic acids are present it is suggested to install equipment as indicated in FIGS. 7,8 and 9 absorption units to remove the above mentioned elements. In this connection basic reacting molecular sieves are suitable in the form of silica gel filter, which can be re-used after re-generation. After these elements have been removed the light liquid meets the quality requirements of low sulphur heating oil.

FIG. 6.1 shows another form of development of a melting reactor 1.1 and a switched crack reactor 1.2 in which the heating input 9 is opposite the pipe distributor 9.3 the heating output 9.4 and the discharge 9.2. Even in this variation the pipes 9 run with the feed coil 2.

FIG. 6.2 shows an embodiment of the melting reactor 1.1 in which preferably all drive elements for feeds and pumps are via magnetic coupling motors 34, under which neither can content liquid leak outwards nor can atmospheric oxygen come into contact with the content liquid 10.3.

On account of the high ambient temperatures the magnets are made from a special cobalt alloy.

FIG. 10 shows a double action piston pump with solenoid drive 35.5 which has no protrusion outwards e.g. piston rods, seals, etc.

Through an external linear drive 35.3 the piston moves in the direction 35.3 of the magnetic force. No plastic material can pass through the free moving valve flap 35.6 which is not completely melted

The effectiveness of pump activity and energy consumed corresponds with an open non-clogging pump in wastewater applications.

FIG. 11 shows a crack reactor 1.2 in its current version fitted with a pipe bundle heat exchanger 9.5. Through the pump 35 the suspension goes into circulation 37.

FIG. 11.1 shows a variation (39) to the circulation pump (35). Through the supply coil (39.2) with pipe side (39.3) the circulation substrate (37) passes through the drive motor (39.5) in the direction of the reference numeral (39.1). In this case the outer pipe (39.4) has a jacket heater not shown here.

The main crack process takes place in the dynamic part of the heat exchanger 9.5 at 420 to 450° C. This heat exchanger 9.5 has 3 parallel-switched streaming routes in which there is a rinsing coil 9.6. In the waiting zone 38 the uncracked long chain hydrocarbons 8 separate.

FIG. 12 shows a coil 9.6 of the heat exchanger which vortexes directly with the suspension 37 (approx. 1 to 20 rpm) across the surface 9.6. Through this effect the surface contact between the suspension 37 and the heating surface (based on scientifically available measurements) is trebled. This means that such a heat exchanger based on the higher efficiency can be reduced to one third.

FIG. 13 shows how under low voltage (against the outer surface of the pipe cladding) the existing coil 9.6 scratches the deposited carbon 8 and with the product flow 37, 9.7 removes it from the heating surfaces. In this way it is ensured that heat transfer is constantly maintained. Since the product consists of an oily mass containing a lubricant abrasion is considered to be very low.

FIG. 14 shows a total concept for an alternative installation to execute the invention process in which instead of a single reactor with a melting and crack zone in accordance with FIG. 1 two downstream reactors 8, 10 are used. As in the previously described example the plastic mix is delivered to the melting reactor through several feeders and melted down. This melting takes place at 250 to 350° C. in which the reactor 8 is warmed by the liquid salt heater 20 and the melt is heated by a heat exchanger 9 as in FIGS. 12 and 13, with which this heat exchanger is connected.

The molten suspension then passes through an overflow to the crack reactor 10 in which the long chain hydrocarbons are cracked at 420 to 450° C. The construction of this crack reactor can be taken from FIG. 11. Also in this crack reactor 10 is a heat exchanger 10.1 consisting of two, three or several parallel pipes in which a rinsing coil 9.6 is incorporated with its own drive e.g. a solenoid drive.

The gas arising from the cracking is condensed in a condenser 10.2 and passes to a Venturi cooler 11 and to a connected pipe bundle cooler 11.1 in which the condensate is cooled. This condensate/vapour mixture cooled down to 30° C. then passes to an intermediate container 15. The high calorie gas can be used for a steam generator 19 or the liquid salt heater 20. The residue taken from the intermediate container 15 can undergo several rinsing stages 22.1, 22.2, 22.3 in which under the process from FIG. 1 contaminants will be removed by absorption. This process leaves light liquid with the quality of light heating oil.

In the crack reactor 10 any remaining long chain hydrocarbons are removed and delivered to an emulsifying container 16 e.g. using ultra-sound and then used for energy in the units 19, 20 (steam generator, liquid salt heater) so that this energy is used for heating the suspension in the melting reactor 8 and in the crack reactor 10. These processes are conducted preferably in an atmosphere of nitrogen under which the nitrogen arises for example from an air separation 25.

FIGS. 15/15.1/15.2 and 16 show another variation whereby molten plastic scrap in a melt pipe 9.5 and the melt using the supply coils (9.6) which is circulated and heated by a heating medium (9) is pumped in directly by the supply screw pump (39).

### DETAILED DESCRIPTION OF THE PREFERRED EMBODIMENTS

The plastic scrap (20) passes into the hopper (21.1) of the feed screw. The feed screw (21.1) feeds the plastic materials to the compactor (22.2). Here the material is compacted and the air withdrawn using nitrogen.

The compactor (22.2) feeds the material into the melt reactor (9.5). The loading of the melt reactor can be stopped using valves (18).

The compacted material is pressed into the melted plastic (10.3) by means of the feed coils (9.6) and this way the liquefying of the plastic material is accelerated as a result of the dissolving effect of the already pre-heated material.

In the first zone of the melt reactor the material is heated to 120° C. max. Any dampness contained in the material (water) will condense and the light elusive components like plasticisers will dissolve and be removed via the bell (9.10) via the contact (11).

Based on the special arrangement of the exchanger (9.5/9.6) heated by liquid salt (9) with a dynamic heat transfer under vortexing (9.10) and the scratching off of contaminants (7) heat transfer happens with a very low Delta-T. In this way a depolymerisation is largely prevented during the liquefying process.

In the following zone the material is further heated until melting takes place. The melt is then transferred by the screw pump (39) into the crack reactor (9.5).

A larger pipe from the crack reactor is fitted with a closed coil that delivers the melt to the sump (10.4) below. It is then further heated up to boiling point. In the other pipes (9.6) from the reactor (9.5) the melt is brought up from the sump (9.7/9.10) and also heated to not less than boiling point.

The melt is thus constantly circulated and then delivered by the outer pumps (9.6) to the upper pot (10.4) of the crack reactor from where using a closed coil (39) it is delivered down below by the middle pipe and then mixed with new melt (10.3) from the melt reactor (9.6/9.7).

Owing to the enormous heat energy input vapour arises on the pipe wall in the outer pipes which rises to the top and increased by the rotating movement of the screws which gives rise to strong vortexes (9.1) contributing to the degassing of the melt and the triggering of the crack process.

The carbon deposits (7) on the pipe walls are rubbed off by the screws (9.6). These deposits together with the unmelted material at the specified temperature are dumped below using valves (18) into a clinker container if required.

A part of the rising vapour (10.6/23) will condense (10.6) in the distillation column mounted directly over the crack reactor and flow back to the crack reactor. The following partial condenser (40) will receive only vapours that do not condense at the specified temperature. This fraction will be cooled later with product (27.1.1) in a steel rinsing pipe (50.1) and condensed. For the separation of the vapour/liquid phase a Zyklon is used.

The liquid product quantity (27.1.1) required for the steel pipe cooler (50.1) is provided by the pump (27.8). This pump sucks the product from the provisional container (27) and feeds it through the heat exchanger (24.6) such that it is cooled to a temperature of 20 to 90° C. before going on to the steel rinsing pipe (50.1).

From this closed product circulation system there is a partial current that takes off any excess to the product container (60).

For the cooling of the compacting screw (27.1.1) and the product via the heat exchanger (24.6) a cooling unit is used. A regulating unit (40.5) is used for this in order to set the temperature in the partial condenser (40).

The vapour (10.6) originating in the crack reactor consists of short and long chain hydrocarbon molecules and rises in the rectification column (40) upwards. By means of contra-flow (rectification) whereby the vapour (10.5) rises and the liquid mixture (10.6) flows downwards an initial thermal fine separation takes place. A column (23.2) is set up with a suitable packing. The column (23.3) and the following partial condenser (40) are arranged for the relevant crucial separation of hydrocarbons C10 up to C24 carbon atoms per molecule. The pre-fractioned vapour that leaves the column flows through a special distributor in the partial condenser (40.1) through which the condensate from the partial condenser is spread on to the column packing.

In the partial condenser an exact temperature is set using cooling pipes. This temperature can be between 150° C. and 300° C. As a heat carrier (cooling medium) thermo-oil (40.2 and 40.3) is used. The regulating set (40.4) functions as a cold and hot battery that maintains the exact temperature for the thermo-oil.

The unique selling point here is that the temperature flexibility in the partial condenser allows the exact setting of the chain length of the gases leaving the crack reactor. If, for example, the partial condenser (40) is run at approx. 300° C. in a following cooler (50) at more than 95% only those molecules are condensed which consist of a chain length of between approx. 10 C to approx. 24 C atoms with the main focus on C12 to C16. This means that the gases leaving the partial condenser at a temperature of approx. 300° C. will in the partial condenser be only those having molecules up to a maximum chain length of C24. Should the temperature be raised/lowered the molecular chain length will be correspondingly increased/decreased.

Equally the setting of the temperature in the cooler following the partial condenser is decisive in producing fuel of a particular type. For example should the temperature in the cooler be 70° C. instead of 30° C. the hydrocarbons C1 to C9 would remain in the form of gas whilst longer chain hydrocarbons condense. The so-called light boilers remaining from the gas phase can be removed and used as process energy. By this separation of the light boilers C1-C9 pure diesel fuel can be made direct.

It must be emphasised that not only the packing (23.5) used but also the distributor between the column and the partial condenser are vulnerable to carbon deposits in case the crack process should be continued here.

The vapour from the partial condenser (10.5.1) is fed into a quencher (50.1) by nozzle where this is condensed with product (27.1.1) into diesel. The nozzle can be filled with diesel at a temperature between 20° C. and 90° C. The two-phase mix from the quencher is separated later in a Zyklon (50). The vapours or gases that leave the Zyklon can be used as combustion gas. The separated liquid (diesel) passes to a water collector (phase collector) (60) whence it flows to a storage tank (27.10).

In order to guarantee a constant supply from the quencher nozzle the product flows firstly into a float container (27) the so-called provisional container for the quencher. A pump (27.8) feeds the product from here via a heat exchanger (24.6) to the quencher nozzle. By means of the heat exchanger (24.6) the required temperature for the quencher can be set. An industrial cooler (25) supplies the necessary cooling water.

Using a level control in the float container (27) and a flow regulator any excess product will be drawn off to a phase separator (60).

The applicant undertakes to consider independent claims on the construction of the single reactor (integral reactor having melting and crack zones, melt reactor 8, crack reactor 10, the relative heat exchangers, pumps and drive units, also the medium used and the stages of the process as laid down in the process scheme in FIGS. 1 and 16) by which the particulars of each sub claim can be made without recourse to the current claim in the matter of independent claims.

### REFERENCE LIST

1 Two-part reactor (interacting tank with overflow)
1.1 Melting chamber (L1)
1.2 Crack chamber (L2)
2 Feed and circulating coil and support for the pipe bundle heating unit. In the pipe bundle system a high degree of mixing is achieved and the heat input in the melt 10.3 and the crack material 10.4 is optimal under this regime. The feed and circulation coils can change the direction of turn and thereby move the product 10.3 and 10.4 forwards and backwards and stir. In normal operation one reverse turn follows two forward turns.
2.1 Torque transfer panel from the drive 1.2 via the heating distribution units 9.3/9.4.
3 Coil to the feed pipe 22.1 and cleaning outer pipe 1.1
4 Wear tracks
5 Contamination (non-organic)
6 Output shaft for 5
6.1 Output unit shown here as a feed coil
6.2 Drive unit with storage and seal
7 Contamination (organic)
8 Output shaft for 7
8.1 Output unit shown here as a feed coil
8.2 Drive unit with storage and seal
9 Pre-heating (thermo salt method)
9.1 Pre-heating in the input area L3 for the increasing of the heat input for melting the material in the reactor 1.1. In the crack reactor 1.2 the internal pre-heating 9.1 is taken to the end of the pipe bundle L4.
9.2 Heating return
9.3 Pre-heating distribution
9.4 Heating distribution chamber return
9.5 Pipe bundle heat exchanger/melting reactor
9.6 Cleaning coil to 9.5
9.7 Inner pipe (product)
9.8 Heating outer pipe
9.9 Diversion chicane for the heating medium
9.10 Product vortexing
9.11 Heating surface
10 Maximum full level corresponds with the overflow height of the wall
10.1 (also skimming wall)
10.1 Skimming wall for separation between chambers 1.1 and 1.2
10.2 Diversion panel for the seal of the overflow 10.3
10.3 molten material between paste and liquid form
10.4 Boiling material in liquid form
10.5 Gas flow from the vaporised plastic material 10.4 from the crack chamber into the distillation column 23
10.5.1 Gas flow as in 10.5 into the quencher
10.6 Return of condensed plastic material parts 10.4 into the melting chamber 1.1/9.5
11 Gas flow from chamber 1.1 to chamber 1.2
12 Drive and storage units to chambers 1.1 and 1.2
12.1 Drive motor with panel and chain wheel
12.2 Chain wheel on drive shaft of the stirrer with power take-up via the heating pipe 9 or 9.2 and drive for the heating distribution units 9.3 and/or combination 9.3 with 9.4
12.3 Shaft seal
13.1 Level control 1.1 for controlling the filling quantity via the raw material inlet 22 and the overflow level gauge 19.2
13.2 Level gauge in the melting reactor
13.3 Temperature controls and monitoring in the melting reactor 1.1 within the range 250 to 350° C.
14.1 Level control and monitoring in the crack chamber 1.2
14.2 Maximum level corresponds with overflow separation panel 10.1
14.3 Minimum level in the crack and vaporising chamber 1.1 must be above the shaft seal 12.3. Should it fall below this the following measures will be triggered:
a) Closing of the valves 16
b) Increased material flow 22.1 into the melting reactor 1.1
14.4 Temperature controls and controls in the crack reactor 1.2 within the range 420 to 450° C.
15 Heat insulation
16 Isolating valve between crack and vaporising reactor 1.2 and the distillation column 23
17 Emergency valve for discharging chambers 1.1 and 1.2 and the floating container 27 into the receptacle 33
18 Isolating valve and lock closure for products
18.1 Isolating valve for nitrogen
18.2 Nitrogen production from ambient air via membrane technology
18.3 Nitrogen low pressure saving for the storage of all container volumes.
18.4 Nitrogen pressure flasks for the storage of all container volumes
18.5 Nitrogen connections
18.6 Rinse exhaust gases
18.7 Quick acting connection with metal hose
19 Change-over valve
20 Plastic material (raw material)
20.1 Equipment (shown here as feed coil)
21 Hopper
21.2 Hopper discharge unit (shown here as feed coil)
22 Compacting unit (shown here as piston pump)
2.1 Input pipe
22.1.1 Input coil
22.2 Compacted plastic material in pallet form
22.3 Through heat input dissolving plastic suspension (goo)
22.4 Cold chamber for the liquid plastic material at a frozen tap such that at storage, movement, valves 18 and piston pump 22 repairs and overhaul can be carried out without draining the container 1.
22.5 Cooling medium in the form of liquid nitrogen
22.6 Cooling sleeve for the cooling of the input product 22.2 and the output product 5 and 7 such that input units 22 and 18 and the drive unit 6.2 and 8.2 and the valve 18 are protected from the effect of the heat emanating from the product of the melt chamber 1.1 and from the crack chamber 1.2.
23 Distillation column
23.1 Container
23.2 Outer heating elements shown here with four sub-circuits. As required the number of elements can be reduced or increased by the introduction of additional heater elements
23.3 Electric heating controls to maintain gas temperatures from 420 to 450° C.
23.4 Temperature controls for 23.3
23.5 Metal body filling to increase the reaction surface
24 Cooler/condensation column (quench)
24.1 Container
24.2 Rinsing chamber
24.3 Spray unit of circulation product 27.1 that as a solvent releases deposits at intervals in the pipe coil cooler.
24.4 Solenoid valve for the control and the setting of the spray intervals 24.3
24.5 Pipe coil cooler
24.6 Cooler for the cooling of the circulating medium 27.1 for the cooling and condensing of the gas flow 10.5
24.7 Spray unit for the cooled circulating product 27.1 for the cooling of the gas flow 10.5. The circulating medium consists of the end product in the form of light heating oil and/or diesel fuel, i.e. the unit is cooled with a finished product. The medium 27.1 with a temperature of approx. 30° C. is reduced to a temperature of approx. 10° C. sprayed over the individual quench zones 24.10 with the spray unit 24.7 and emerges in the increasingly cooling and condensing 27.1 gas flow 10.5 as a liquid mixture of new product and circulating medium 27.1 at the outlet of the column as product 27.2.
24.8 Regulating valve for the cooled circulating medium 27.1
24.9 Temperature regulator for 24.8
24.10 Metal body filling to increase the reaction surface. The individual quench elements shown here with spray units 24.7 and body filling 24.10 can be reduced as required in the process or increased with additional elements.
Central cooling unit for the maintenance of the coolant 24.5, 24.6 and 6 off 22.6
25.1 Cooling output
25.2 Cooling return
26 Heat return from the pipe coil cooler 24.5 for the heating of equipment not directly connected with the unit or heat exchanger (e.g. room heating, absorption cooler, etc.)
26.1 Input cold
26.2 Return warm
26.3 Heat exchanger
26.4 Input warm to the consumer
26.5 Return cold to the consumer
27 Product output and separation container
27.1 Product and/or circulation medium
27.1.1 Cooled product or circulation medium
27.2 Highest water level
27.3 Lowest water level. With gas flow 10.5 water moisture is also taken along and in the quencher 24 condensed out. As the product is lighter than water the water 27.7 sinks to the bottom of the container with the other impurities 27.5.
27.4 With float detection the separation between light liquid 27.1 and the water 27.7 can be defined to the last millimetre. Should the maximum level 27.2 be reached the solenoid valve 27.5 will open until the lower level 27.3 is reached.
27.5 Organic matter
27.6 Collecting and storage containers
27.7 Water
27.8 Circulation medium 27.1 feed pump to the cooler 24.6
27.9 Overflow level for absorption treatment unit 28 and 29
27.10 Purified end product (diesel fuel) in storage tank 30
28 Absorption treatment unit Version 1 with temporary containers 28.1 to 28.3 for the separation of sulphur containing matter, halogen matter such as HCL (hydrochloric acid) and any other foreign organic acids. Shown here (FIG. 7) are two groups 28.5 and 28.6 that are run on an alternating basis. If one group is loaded so it changes to the other group. If one group is emptied or individual containers changed the feed 27.6 is stopped 18 and nitrogen 18.5 applied over the open valves 18.1 and then the outflow valve (18) opened and via the connection 18.7 and 28.8 the residual liquid 28.9 is pumped back to the container 27. At the same time as the emptying process the container content 28.4 is filled with nitrogen and rendered inert. Then all valves are closed and the container uncoupled with the fasteners 18.7, filled with nitrogen and then by opening the valves 18 re-started.
28.1 Up to 28.3×N removable containers
28.4 Absorption packing materials such as silicate gel etc. that absorbs and binds foreign matter from the product 27.1.
28.4.1 Loaded absorption matter
28.5 Absorption group 1
28.6 Absorption group 2
28.7 Feed pump for emptying 28.8
28.8 Emptying liquid in the containers 27
29 Absorption treatment unit Version 2. Contrary to absorption treatment unit Version 1 28 the containers remain but the absorption packing 28.4 is fed inwards and outwards by sluices 29.2 and 29.8.
29.1 Filling hopper for absorption material 28.4
29.2 Filling sluice with nitrogen rinsing 18.5 before filling
29.3 Containers in packing 28.4
29.4 Non-continuous downstream of the packing 28.4
29.5 Output unit for loaded packing 28.4 shown here as a screw or coil feed.
29.6 Feed for the light liquid 27.9 to be treated
29.7 Filter for the packing flow 28.4
29.8 Outlet sluice with nitrogen 18.5 for the loaded absorption material 28.4.1
29.9 Circulation system between the absorption treatment unit 28.4 shown here as three elements. If necessary the number of elements 29 can be reduced or increased.
30 End product tank unit for diesel fuel 27.10
31 Emulsion unit for reclaiming as fuel for the production of intrinsic energy.
31.2 Collection and emulsion container
31.3 Feed line for materials 31.2
31.4 Pump for the supply of intermediate product 27.1
31.5 Feed line for mixed product from 31.2 and 31.4 in containers 31.1
31.6 Circulation and mixed pump via cooler 22.6
31.7 Static mixer
31.8 Ultra-sound emulsifier for the production of a combustible high calorie emulsion from the organic materials 8 liquids from the crack reactor 1.2 and from the material mixture 31.5
31.9 Emulsion
32 Heat generating plant for the heating of the thermo salt for the heat consumer.
32.1 Exhaust gasses from the product collection container 27
32.2 Gas movement fan
32.3 Transport and pressure increasing pump
32.4 Multi-fuel burner for the production of energy from gas 32.1 and from emulsion 31.9
32.5 High temperature boiler for the heating of thermo salt above 500° C.
32.6 Thermo salt circulation
32.7 Thermo salt pre-run
32.8 Thermo salt return
32.9 Heating oil tank for average operation
33 Safety and emergency overflow measures. In normal or revision the entire reactor content 1 must be fed into the collection container 33.1 so that the material mixture 10.3 and 10.4 remains compatible with the pump.
33.1 Steel tank filled with nitrogen 18.5
33.2 Heating jacket with thermo salt heating
33.3 Circulation and refill pump
33.4 Thermo salt heated heat exchanger
33.5 Emergency outlet from the reactor 1 chambers 1.1 and 1.2 into the container 33.1 via valves 17
33.6 Circulation through the heat exchanger 33.4
33.7 Supply for the refilling from the container 33.1 via the pump 33.3 and the multi-way valve 19 into the feed line 33.7 to chamber 1.1
34 Solenoid drive or motors with special cooling
35 Product circulation pump in the form of a rotary pump or as a double action piston pump (see FIG. 10)
35.1 Drainage duct
35.2 Pressure duct
35.3 Piston movement
35.4 Linear drive
35.5 Magnet
35.6 Flap valve
36 Circulation for heating and melting of the suspension 22.3 in the feed pipe 22.1
37 Suspension circulation in the crack reactor
37.7 Pump body
38 Idle zone
39 Outer pipe coil pump
39.1 Pump direction coil pump (39)
39.2 Coil
39.3 Central pipe
39.4 Outer pipe
39.5 Solenoid drive or motor with special cooling
40 Partial condenser
40.1 Cooling hoses
40.2 Cooling return
40.3 Cooling pre-run
40.4 Thermo oil heater
40.5 Electric heater
40.6 Circulation pump
40.7 Controls between (40.8/40.6/40.5)
40.8 Temperature measurement
41 Gasses
42 Condensate hydrocarbons
50 Combined quenching/steel pipe cooler (50.1) with Zyklon separator (50.2)
50.1 Steel pipe cooler
50.2 Wet Zyklon
50.3 Moistened surfaces
60 Combined hopper with water separator
60.1 Container
60.2 Division
60.3 Sinking water

### REFERENCE LIST FOR FIG. 14

1 Supply station
1.1 Dosing bottom discharger
1.2 Piston pump
2 Upper supply
3 Distribution
4.1 Loading silo I
4.2 Loading silo II
5.1 Filling coil I with solenoid drive (MMA)
5.2 Filling coil II with solenoid drive (MMA)
6 Material coil
7 Inlet and pre-melt coil with MMA
8 Melting reactor 250-350° C.
8.1 Supply coil with MMA
8.2 Foreign body removal
9 Heat exchanger with coil cleaner with MMA and heating medium in melted salt
10 Crack reactor 420-450° C.
10.1 Heat exchanger as item 9
10.2 Condenser
10.3 Carbon output
11 Venturi cooler with cold liquid from the product
11.1 Pipe bundle cooler
11.2 Wet detonation arrester
11.3 Gas detonation arrester
12 Bench cooler
13 Compressor cooler
14 Pipe bundle cooler
15 Intermediate product container (30° C.)
15.1 Water and intermediate product mixture
16 Emulsion container
16.2 Emulsion unit (ultrasound)
17 Foreign body container (for thermo disposal)
18 Emergency collection and revision container for the whole melting, crack and intermediate product content (with steam heating)
19 Steam generator
19.1 Water preparation for 19
20 Liquid salt heater (500° C.)
20.2 Liquid circulation pump for the heat consumers
21 Gas flare unit
22 Intermediate product take-off with dosing pump and detonation arrester
22.1.3 Cleaning steps (e.g. silicate gel for the absorption of foreign matter)
24 Diesel fuel/or light heating oil
25 Nitrogen (N2) generated from air separation pressure vessel

1-54. (canceled)

55. A method for preparing a waste containing plastic materials and organic liquids based on one of mineral oil, edible oil, fat and similar, the method comprising the following steps:
feeding a mixture into a reactor;
melting the mixture in a melting zone of the reactor;
removing foreign matter from the melt;
cracking, in a crack zone of the reactor, long chain polymers in the melt until the long chain polymers transform into a gas phase;
outputting the gas phase from the reactor;
condensing the gas phase in a cooler;
removing impurities from a liquid remaining after condensing in the cooler (quencher); and
retaining the purified liquid.

56. The method according to the claim 55, further comprising the step of varying a chain length of gas molecules of the gas phase with a partial condenser stage applied to the cooler.

57. The method according to claim 56, further comprising the step of preparing the chain length of the molecules to a variable temperature during partial condensing.

58. The method according to claim 56, further comprising the step of setting the temperature at partial condensing between 150° C. and 350° C.

59. The method according to claim 56, further comprising the step of separating, by a thermal fine separation, short chain molecules and long chain molecules prior to partial condensing.

60. The method according to claim 59, further comprising the step of pre-fractioning out hydrocarbons, having a molecule chain length C10 to C24, during the thermal fine separation.

61. The method according to claim 59, further comprising the step of utilizing contra-flow distillation in the thermal fine separation.

62. The method according to claim 55, further comprising the step of returning condensed long chain molecules to the crack zone.

63. The method according to claim 55, further comprising the step of utilizing short chain hydrocarbons, present in the gas phase after the cooler, as fuel energy.

64. The method according to claim 63, further comprising the step of determining the type of fuel energy by setting a temperature during condensing.

65. The method according to claim 55, further comprising the step of setting a temperature in the melting zone to approximately between 250° C. to 350° C. and in the crack zone to approximately between 420° C. to 450° C.

66. The method according to claim 55, further comprising the step of removing impurities of non-melted plastic materials in the melting zone.

67. The method according to claim 55, further comprising the step of accelerating melting in the melt zone with melt which functions as a supplementary melting agent for melting the plastic materials.

68. The method according to claim 55, further comprising the step of removing, in the crack zone during cracking, substances in a form of hydrocarbon excess and not in the gas phase.

69. The method according to claim 68, further comprising the step of emulsifying the removed substances and utilizing the emulsified removed substances as fuel energy.

70. The method according to claim 55, further comprising the step of removing impurities containing at least one of sulphur, halogen acids and organic acids from the liquid remaining after condensation and cooling (quenching).

71. The method according to claim 55, further comprising the step of continuously operating one of the reactor or reactors.

72. The method according to claim 55, further comprising the step of compacting the mixture before feeding the mixture to the reactor.

73. The method according to claim 55, further comprising the step of feeding a portion of the liquid remaining, after condensing, via a cooler to cool and condense a flow of the gas phase.

74. A device for preparing a material mixture containing a plastic waste and organic liquids based on at least one of mineral oil, edible oil, fat or similar with a reactor arrangement having a melting zone and a crack zone and in which the material requires a suitable device through at least one of the melting zone and the crack zone.

75. The device according to claim 74, wherein one of two reactors or one of an insulated wall or baffle is arranged downstream between the melting zone and the crack zone.

76. The device according to claim 75, wherein each of the melting zone and the crack zone has a screw feed.

77. The device according to claim 74, wherein the device for preparing the material has at least one material inlet for delivering the material mixture.

78. The device according to claim 77, wherein the device for preparing the material has at least two material inlets for delivering the material mixture into the reactor arrangement from two directions at a tangent to each other.

79. The device according to claim 77, further comprising at least one material inlet and a single melting zone.

80. The device according to claim 79, wherein the melting zone has a maximum temperature of 150° C.

81. The device according to claim 77, further comprising at least one material inlet and one screw feed.

82. The device according to claim 80, further comprising a material feed screw equipped with a circular outer jacket heater.

83. The device according to claim 82, wherein a heat medium is transferable to an interior of the material feed screw.

84. The device according to claim 82, wherein the circular outer jacket heater is a heat exchanger.

85. The device according to claim 84, wherein the heat exchanger is heated by liquid salt.

86. The device according to claim 76, wherein the screw feed has the facility to remove the material from an inner surface.

87. The device according to claim 74, wherein a temperature of the melting zone and the crack zone are controlled independently.

88. The device according to claim 74, further comprising a compactor for compacting of the material mixture in a material inlet.

89. The device according to claim 79, wherein the compactor presses the material mixture into the melt in the melting zone inlet.

90. The device according to claim 74, further comprising a distillation column in which after cracking, residual long chain molecules are condensable and are extractable from short chain molecules as gas phase.

91. The device according to claim 74, further comprising a partial condenser which releases molecules of a specified length in a gas phase.

92. The device according to claim 91, wherein the partial condenser has a cooling/heating unit which is designed for setting a specified temperature in the partial condenser.

93. The device according to claim 92, wherein the cooling/heating unit has a medium, which by means of a temperature unit is adjustable to a required set temperature.

94. The device according to claim 91, wherein the partial condenser has a temperature of 150° C. to 350° C.

95. The device according to claim 90, further comprising a cooler for condensing of light liquid forming part of the gas phase after at least one of the distillation column and the partial condenser.

96. The device according to claim 95, wherein the cooler has a heating/cooling unit which sets a defined temperature in the cooler.

97. The device according to claim 96, further comprising an absorption unit for absorption of impurities from the light liquid.

98. The device according to claim 97, wherein in which the absorption unit has several absorbers that alternatively absorb and re-generate.

99. The device according to claim 98, wherein the absorption unit has an absorber with a required medium to re-generate from the absorber and regenerated absorption medium is fed to the absorber.

100. The device according to claim 74, wherein the reactor is arranged horizontally.

101. The device according to claim 74, wherein heating pipes are contained within the reactor.

102. The device according to claim 101, further comprising a heat medium inlet (9) with a pipe distributor (9.3) and a heat medium outlet (9.2) with an outlet distributor (9.7) on the opposing front side of the reactor (1.1; 1.2).

103. The device according to claim 74, wherein the reactor is fitted with at least a heat exchanger (9; 9.5; FIG. 14: 9: 10.1) in which one of a suspension or a melt is heatable.

104. The device according to claim 103, wherein the heat exchanger (FIGS. 12, 13: 9.5) is arranged as a pipe heat exchanger with a coil fitted as an inner pipe (FIGS. 12, 13: 9.6) that contains the suspension.

105. The device according to claim 104, wherein the coil (FIGS. 12, 13: 9.6) touches the surface such that any adhering residues removable.

106. The device according to claim 74, wherein pumps, feeds and other equipment in contact with other parts are driven by solenoid drives (FIGS. 13: 34).

107. The device according to claim 74, wherein at least one pump (FIGS. 10: 35) is a double action pump with two cylinders which are separated from a piston (FIGS. 10: 35.5) and which are drivable by a solenoid drive (35.5).

108. The device according to claim 107, wherein the solenoid drive (FIG. 10: 35.5) has an external point which is driven from one of a linear drive (FIG. 10: 35.4) or similar.
